(19) United States
(12) Patent Application Publication
(10) Pub. No.: US 2026/0001170 A1
(43) Pub. Date: Jan. 1, 2026

(54) EMBEDDING CASSETTE MARKING MACHINE AND OPERATING METHOD

(71) Applicant: DAKEWE (SHENZHEN) MEDICAL EQUIPMENT CO., LTD., Shenzhen (CN)

(72) Inventors: Changyou LIAO, Shenzhen (CN); Zengguang JIA, Shenzhen (CN); Xufeng YIN, Shenzhen (CN); Youfa WANG, Shenzhen (CN); Yuan JIANG, Shenzhen (CN); Changxin LI, Shenzhen (CN); Xiongbing ZHOU, Shenzhen (CN); Wentao LI, Shenzhen (CN); Weiwei LONG, Shenzhen (CN); Hui LIU, Shenzhen (CN); Yuhao TANG, Shenzhen (CN); Junfeng HE, Shenzhen (CN)

(21) Appl. No.: 19/318,759

(22) Filed: Sep. 4, 2025

Related U.S. Application Data
(63) Continuation of application No. PCT/CN2024/093897, filed on May 17, 2024.

(30) Foreign Application Priority Data
Mar. 21, 2023 (CN) 2023103172013
Apr. 1, 2023 (CN) 2023103833849

(51) Int. Cl. B23K 26/70; B23K 26/08; B23K 26/142; B23K 26/36; B23K 101/12; B65G 47/44; B65G 47/88

(52) U.S. Cl. CPC B23K 26/702; B23K 26/083; B23K 26/142; B23K 26/36; B65G 47/44; B65G 47/8853; B23K 2101/12; B65G 2201/0235

(57) ABSTRACT

An embedding cassette marking machine and an operating method are provided. The embedding cassette marking machine includes: a housing; a feeding mechanism; a laser marking mechanism for marking the embedding cassette that slides down to the slideway assembly; and a discharging mechanism, which includes a pushing assembly and a material-carrying rail. The pushing assembly includes a pushing block, and the pushing block is configured to reciprocate toward or away from the material-carrying rail, so as to push the marked embedding cassette to the material-carrying rail.

### CROSS-REFERENCE TO RELATED APPLICATIONS

This application is a National Stage of International Application No. PCT/CN2024/093897 filed on May 17, 2024, which claims priority to Chinese Patent Application No. 2023103172013 entitled “STOPPING APPARATUS FOR LOADING AND UNLOADING EMBEDDING CASSETTE” filed with China National Intellectual Property Administration on Mar. 21, 2023, the entire content of which is incorporated herein by reference; and also claims priority to Chinese Patent Application No. 2023103833849 entitled “EMBEDDING CASSETTE MARKING MACHINE AND OPERATING METHOD” filed with China National Intellectual Property Administration on Apr. 1, 2023, the entire content of which is incorporated herein by reference.

### TECHNICAL FIELD

The present disclosure relates to the technical field of medical equipment, and in particular, to an embedding cassette marking machine and an operating method.

### BACKGROUND

An embedding cassette is a container for storing pathological specimens. In order to identify the embedding cassette, it is necessary to mark characters such as a two-dimensional code, a pathological number, and patient identity information on the embedding cassette. An embedding cassette marking machine is a device that prints numbers on embedding cassettes in batches. By marking each embedding cassette, it is convenient to distinguish the embedding cassettes and prevent the embedding cassettes from being confused with each other. However, the embedding cassette marking machine in related art has low levels of automation and intelligence.

### SUMMARY OF THE INVENTION

In view of the above-mentioned existing situation, the present disclosure provides an embedding cassette marking machine and an operating method.

A first aspect of the present disclosure provides an embedding cassette marking machine, including a bottom plate, a frame, and a housing, wherein the frame is disposed on the bottom plate, and the housing is disposed on the frame; a feeding mechanism disposed in the housing, wherein the feeding mechanism includes a conveying assembly, a loading assembly, and a slideway assembly, the conveying assembly is arranged to correspond to the loading assembly, and the loading assembly is arranged to correspond to an inlet of the slideway assembly; and the loading assembly is configured to load a plurality of embedding cassettes, and the conveying assembly is configured to push the embedding cassette on the loading assembly to move toward the inlet of the slideway assembly, and the slideway assembly includes a slideway, and one end of the slideway relatively adjacent to the ground is provided with a first block and a second block, the first block is configured to be movable, and the second block is closer to a bottom end of the slideway than the first block; a laser marking mechanism, including a marking member and a laser, wherein the marking member is connected to the laser, and the marking member is disposed on an upper side of the first block to mark the embedding cassette that slides down to the first block; a discharging mechanism, including a pushing assembly and a material-carrying rail, the pushing assembly is in transmission connection with the first block, the material-carrying rail is arranged to correspond to the second block, and the pushing assembly includes a pushing block, the pushing block is configured to reciprocate toward or away from the material-carrying rail.

By adopting the above technical solution, the conveying assembly pushes the embedding cassette in the loading assembly to move to an upper side of the slideway relatively away from the ground, and the embedding cassette slides down the slideway under the action of gravity. When the embedding cassette slides down the slideway to a position relatively adjacent to a bottom end of the slideway, the embedding cassette is stopped by the first block. The laser is started, and the marking member performs laser marking on the embedding cassette. After the embedding cassette is laser marked, the first block moves away from the slideway under the drive of the pushing block, gradually separating from the slideway until the marked embedding cassette loses the blocking of the first block and continues to slide down the slideway to the second block. Then the pushing block drives the first block to move toward the slideway and abuts against the marked embedding cassette, and the first block pushes the marked embedding cassette to move toward the material-carrying rail until the marked embedding cassette is completely pushed out of the slideway, and the marked embedding cassette is located on the material-carrying rail.

In an embodiment of the present disclosure, the embedding cassette marking machine further includes a filtering mechanism, which includes a dust filtering member, a gas filtering member, and a first blower. A through hole is provided at an overlapping position of the slideway and the marking member, the dust filtering member is arranged to correspond to the through hole, the first blower is disposed on a side of the dust filtering member relatively away from the through hole, and the gas filtering member is in communication with the dust filtering member.

By adopting the above technical solution, the filtering mechanism can filter dust and purify gas. The embedding cassette is made of plastic, and after laser marking, toxic gas with pungent odor and particles such as dust is generated. After the laser is started, the first blower is started synchronously, and the first blower sends air in a direction away from the dust filtering member, so that negative pressure is generated inside the dust filtering member. The dust and gas generated after the embedding cassette is laser marked enter the dust filtering member through the through hole under the action of negative pressure, and the dust filtering member filters the dust into the dust filtering member. The gas flows through the dust filtering member to the gas filtering member, and the gas with pungent odor is purified in the gas filtering member. The environmental protection level of the embedding cassette marking machine is improved.

In an embodiment of the present disclosure, the embedding cassette marking machine further includes a display mechanism, the display mechanism includes a display control screen and a power supply assembly, and the power supply assembly is electrically connected to the display control screen.

By adopting the above technical solution, after the display control screen is connected to the power supply assembly, a user can set the number of the embedding cassettes to be marked via the display control screen, simplifying the process of the user using the embedding cassette marking machine, facilitating the user's operation, and providing great convenience for the user.

In an embodiment of the present disclosure, the embedding cassette marking machine further includes a heat dissipation mechanism, the heat dissipation mechanism includes a first air inlet, a second air inlet, a third air inlet, a first air outlet, and a second air outlet, the first air inlet is provided on a side of the housing adjacent to the display control screen, the second air inlet is provided on a side of the housing adjacent to the power supply assembly, the first air outlet is correspondingly provided with a second blower, and the second air outlet is configured to enable heat emitted by the laser to be discharged through the second air outlet.

By adopting the above technical solution, the first air inlet, the second air inlet, and the first air outlet are in communication with each other to form a first heat dissipation duct to dissipate heat from the display control screen and the power supply assembly. The third air inlet is in communication with the second air outlet to form a second heat dissipation duct to dissipate heat from the laser. When the second blower is started, airflow enters the housing from the first air inlet, passes through the display control screen and takes away heat emitted by the display control screen, and finally the heat is discharged from the first air outlet; airflow enters the housing from the second air inlet, passes through the power supply assembly and takes away heat emitted by the power supply assembly, and finally the heat is also discharged from the first air outlet. The heat generated by the laser is discharged from the second air outlet under the convection between the third air inlet and the second air outlet.

In an embodiment of the present disclosure, the housing includes a maintenance door, and the maintenance door is detachably disposed on a side of the housing adjacent to the slideway assembly.

By adopting the above technical solution, the user can open the maintenance door to inspect and maintain the interior of the embedding cassette marking machine. When the dust filtering member is clogged, the user can open the maintenance door to replace or clean the dust filtering member, preventing the dust filtering member from being clogged and the filtering mechanism from failing to work properly.

In an embodiment of the present disclosure, the loading assembly includes a loading box and a transition plate, the transition plate is disposed on a side of the loading box relatively away from the conveying assembly, a side of the transition plate relatively away from the loading box corresponds to the inlet of the slideway, and an embedding cassette pressing block is disposed in the loading box.

By adopting the above technical solution, the feeding process of the embedding cassette is smoother. The embedding cassette is light in weight, and the embedding cassette pressing block can tightly press the embedding cassette in the loading box, so that the conveying assembly can be docked with the embedding cassette more accurately to push the embedding cassette to move toward the transition plate. After being pushed out of the loading box, the embedding cassette first passes through the transition plate and then enters the slideway to prevent the embedding cassette from being stuck during movement, making the feeding process of the embedding cassette smoother and improving the fluency of embedding and feeding.

In an embodiment of the present disclosure, a fan is disposed in the laser.

By adopting the above technical solution, when the laser is operating, the fan also operates synchronously to dissipate heat from the laser. When the fan is operating, convection is formed between the third air inlet and the second air outlet, and airflow enters the housing from the third air inlet, passes through the laser and takes away heat, and the heat is discharged from the second air outlet.

An operating method of an embedding cassette marking machine includes the following steps:
providing a baffle movably disposed at an outlet of the slideway, a first block gradually overlapping with the slideway under the drive of a pushing block, and the baffle rising to block the outlet of the slideway; actuating a conveying assembly to push an embedding cassette in a loading assembly to move to a slideway assembly, such that the embedding cassette slides down the slideway to the first block; operating a marking member to perform laser marking on the embedding cassette; lowering the baffle to open the outlet of the slideway, and actuating the pushing block to move the first block away from the slideway; allowing the embedding cassette to slide down to a second block, and driving the pushing block to move the first block toward the slideway to push the embedding cassette from the outlet of the slideway to a material-carrying rail.

By adopting the above technical solution, when the first block overlaps with the slideway, the baffle rises to block the outlet of the slideway, preventing the embedding cassette from being separated from the slideway through the outlet of the slideway when the embedding cassette slides down the slideway to the first block. After the marking member marks the embedding cassette, the baffle is lowered, so that the pushing block can drive the first block to push the embedding cassette through the outlet of the slideway and enter the material-carrying rail.

In an embodiment of the present disclosure, in the step of performing laser marking on the embedding cassettes, the first blower is started, and the dust filtering member filters dust. If the rotation speed of the first blower decreases, it indicates that the dust filtering member is blocked; the second blower is started, and the heat of the display control screen and the power supply assembly is discharged from the first air outlet; the fan is started, and heat from the laser is discharged from the second air outlet.

By adopting the above technical solution, after the embedding cassette is laser marked, the first blower is started, and the dust and gas generated after the embedding cassette is laser marked are sucked into the dust filtering member. After the embedding cassette marking machine has been used for a period of time, the dust filtering member continuously filters dust, and the dust is easy to block the dust filtering member. If the rotation speed of the first blower decreases, it indicates that the dust filtering member is blocked, and the user can replace or clean the dust filtering member in time to ensure the normal operation of the filtering mechanism.

The second blower is started, and airflow enters the housing from the first air inlet and the second air inlet, passes through the display control screen and the power supply assembly respectively, takes away the generated heat, and the heat is discharged from the first air outlet.

The fan is started to strengthen the convection between the third air inlet and the second air outlet, so that airflow enters from the third air inlet and the heat from the laser is discharged from the second air outlet.

In an embodiment of the present disclosure, a maintenance door sensor is provided. If the maintenance door is detached from the housing, the embedding cassette marking machine stops operating.

By adopting the above technical solution, when the maintenance door is mounted on the housing, the embedding cassette marking machine can operate normally. If the maintenance door is disassembled and detached from the housing, the embedding cassette marking machine stops operating, preventing maintenance personnel from being injured if the embedding cassette marking machine is started while the maintenance door 1011 is detached from the housing 101 during maintenance, thereby improving safety performance.

In an embodiment of the present disclosure, the embedding cassette marking machine further includes a conveying mechanism and a loading mechanism arranged to correspond to the conveying mechanism, wherein the loading mechanism holds a conjoined embedding cassette, the conjoined embedding cassette includes an embedding cassette body and an embedding cassette cover, and the embedding cassette body is connected to the embedding cassette cover; a sliding mechanism and a blocking mechanism disposed on the sliding mechanism, wherein the sliding mechanism includes a slideway, the blocking mechanism includes a first baffle and a second baffle, the slideway is inclined with respect to the ground, the first baffle and the second baffle are respectively disposed on opposite sides of the slideway, the slideway includes an inlet of the slideway corresponding to the loading mechanism, and a stopping block is disposed at a bottom end of the slideway to stop the conjoined embedding cassette at the bottom end of the slideway; a pushing mechanism, including a buffer block, wherein the buffer block is movably disposed on the slideway relatively adjacent to a bottom end of the stopping block, so that the conjoined embedding cassette is first stopped and buffered by the buffer block and then slides down to the stopping block, and the buffer block is provided with a first inclined portion, so that the embedding cassette cover can pass through an inclined surface of the buffer block, while the embedding cassette body is still stopped at the buffer block.

By adopting the above technical solution, the loading mechanism provides the conjoined embedding cassette, and the conveying mechanism can push the conjoined embedding cassette placed on the loading mechanism. The conjoined embedding cassette enters the slideway through the inlet of the slideway under the push of the conveying mechanism, and slides down to the bottom end of the slideway under the action of gravity. The first baffle and the second baffle block opposite sides of the slideway to prevent the conjoined embedding cassette from being separated from the slideway from opposite sides of the slideway during the sliding process. Both the buffer block and the stopping block are disposed on the slideway with a certain distance between them. The buffer block can move away from the slideway, and the stopping block is fixedly disposed at the bottom of the slideway. During the sliding process of the conjoined embedding cassette on the slideway, the conjoined embedding cassette first slides down to the buffer block to buffer the sliding speed of the conjoined embedding cassette, and then the buffer block moves away from the slideway. When the buffer block moves to a position where the buffer block does not contact the slideway, the conjoined embedding cassette continues to slide down to the stopping block.

The conjoined embedding cassette includes an embedding cassette body and an embedding cassette cover. When the embedding cassette cover is opened and slides down together with the embedding cassette body, the embedding cassette cover first reaches the bottom end of the slideway and does not contact the slideway. The first inclined portion provided on the buffer block enables the embedding cassette cover to pass through the buffer block, while a portion of the buffer block without the first inclined portion blocks the embedding cassette body, so that the entire conjoined embedding cassette cannot continue to slide down. If the embedding cassette cover is covered on the embedding cassette body or only the embedding cassette body is left to slide down the slideway, the buffer block can block various types of embedding cassettes. If the embedding cassette slides directly to the stopping block, it is easy to rush out of the stopping block and be separated from the slideway. However, if the embedding cassette first slides down to the buffer block and then slides down to the stopping block, it is ensured that the embedding cassette will not be separated from the slideway due to excessive sliding speed when sliding down to the stopping block. An embedding cassette loading and unloading stopping apparatus provided by the present disclosure can not only further prevent the embedding cassette from being separated from the slideway during the sliding process, but also enable various types of embedding cassettes to slide down smoothly.

In an embodiment of the present disclosure, the pushing mechanism further includes a pushing block, the pushing block is connected to the buffer block, the pushing block is movably disposed on a side of the slideway, and a moving direction of the pushing block is toward or away from the slideway.

By adopting the above technical solution, during the sliding process of the embedding cassette on the slideway, the pushing block moves toward the slideway, and the buffer block gradually overlaps with the slideway, so that the embedding cassette slides down to the buffer block. Then the pushing block moves away from the slideway, the buffer block gradually separates from the slideway, and the embedding cassette slides down to the stopping block. The pushing block then moves toward the slideway, driving the buffer block to gradually overlap with the slideway, so as to push the embedding cassette to move away from the slideway. The buffer block can not only play a buffering role, but also can push the embedding cassette to a corresponding position under the action of the pushing block so that the user can take the embedding cassette.

In an embodiment of the present disclosure, the sliding mechanism further includes a material-carrying rail. The material-carrying rail is disposed on a side of the slideway relatively adjacent to the loading mechanism, and the pushing block is disposed on a side of the slideway relatively away from the loading mechanism to push the conjoined embedding cassette to move toward the material-carrying rail.

By adopting the above technical solution, under the action of the pushing block, the buffer block pushes the embedding cassette located at the stopping block to move toward the material-carrying rail. The embedding cassettes are pushed onto the material-carrying rail in sequence, which is convenient for the user to take the embedding cassettes in order. The traditional material-carrying rail is usually arranged on the side of the slideway relatively away from the loading mechanism, and the arrangement order of the embedding cassettes on the material-carrying rail is reversed, which does not conform to human usage habits. However, in the apparatus provided by the present disclosure, the position of the material-carrying rail makes the arrangement of the embedding cassettes in a forward order, which is more in line with human usage habits.

In an embodiment of the present disclosure, the slideway further includes an outlet of the slideway corresponding to the material-carrying rail, the blocking mechanism further includes a third baffle communicatively connected with the pushing block, the third baffle is movably disposed at the outlet, and the third baffle is configured to regulate a sliding direction of the conjoined embedding cassette according to a moving direction of the conjoined embedding cassette.

By adopting the above technical solution, during the sliding process of the embedding cassette on the slideway, the pushing block starts to move, and the third baffle moves upward to the outlet of the slideway to block the outlet of the slideway, preventing the embedding cassette from falling from the outlet of the slideway and failing to slide to a correct position. When the embedding cassette slides down to the stopping block, the third baffle moves downward to open the outlet of the slideway, and the buffer block moves toward the slideway to push the embedding cassette from the outlet of the slideway to the material-carrying rail.

In an embodiment of the present disclosure, the pushing mechanism further includes a first sensor, the first sensor is disposed on a side of the slideway relatively away from the outlet of the slideway, and the third baffle is communicatively connected with the first sensor.

By adopting the above technical solution, when the embedding cassette slides down to the buffer block and the sensor detects the embedding cassette, marking starts. After the marking is completed, the third baffle moves downward to open the outlet of the slideway. The pushing block moves away from the outlet of the slideway, the buffer block gradually separates from the slideway, and the marked embedding cassette slides down to the stopping block. Then the pushing block moves toward the outlet of the slideway, and the buffer block pushes the embedding cassette through the outlet of the slideway to the material-carrying rail.

In an embodiment of the present disclosure, an anti-flying baffle is disposed on an upper side of the buffer block, and the anti-flying baffle is connected to the first baffle and the second baffle.

By adopting the above technical solution, the anti-flying baffle can further prevent the embedding cassette from being separated from the slideway when the embedding cassette slides down to the buffer block. When the embedding cassette is thrown upward out of the slideway, the anti-flying baffle can block the embedding cassette from being separated from the slideway.

In an embodiment of the present disclosure, the loading mechanism includes a loading slot and a support plate arranged to correspond to the loading slot, the loading slot is disposed on a side relatively adjacent to the conveying mechanism, the support plate is disposed on a side relatively adjacent to the slideway, and a second inclined portion is disposed at an inlet of the support plate.

By adopting the above technical solution, the embedding cassette is placed in the loading slot, and the conveying mechanism pushes the embedding cassette in the loading slot to move to the corresponding support plate. The second inclined portion can make the embedding cassette move from the loading slot to the support plate more smoothly, and it is not easy to be stuck at a transition region between the loading slot and the support plate. The embedding cassette smoothly moves to the support plate through the second inclined portion, and then continues to be pushed to the slideway by the conveying mechanism.

In an embodiment of the present disclosure, a sliding shaft is provided on the support plate, and a third inclined portion is provided at an end of the sliding shaft adjacent to the inlet of the slideway.

By adopting the above technical solution, the conveying mechanism pushes the embedding cassette to move from the loading slot to the support plate, and the embedding cassette passes through the sliding shaft during the process of moving from the support plate to the slideway. The third inclined portion at the end of the sliding shaft adjacent to the inlet of the slideway makes it easier for the embedding cassette to transition to the slideway under the action of gravity.

In an embodiment of the present disclosure, a fourth baffle is disposed on an upper side of the support plate.

By adopting the above technical solution, the fourth baffle can further protect the embedding cassette from being separated from the support plate and the slideway.

An embedding cassette marking machine includes the embedding cassette loading and unloading stopping apparatus as described above.

In summary, the technical solution provided by the present disclosure includes at least one of the following technical effects:

1. By providing a conveying assembly corresponding to the loading assembly, the conveying assembly can push the embedding cassette in the loading assembly to move to the slideway. The embedding cassette slides down to the first block on the slideway, and at this time, the embedding cassette marking machine performs laser marking on the embedding cassette. After the laser marking of the embedding cassette is completed, the pushing block drives the first block to move away from the slideway until the first block is completely separated from the slideway, and the embedding cassette slides down to the second block. The pushing block drives the first block to move toward the slideway, and the embedding cassette gradually separates from the slideway. When the first block completely overlaps with the slideway, the embedding cassette is completely pushed out of the slideway and enters the material-carrying rail.

2. By providing a filtering mechanism inside the housing, dust and gas with pungent odor generated after laser marking can be filtered out. When the embedding cassette is laser marked, the first blower is started to generate negative pressure inside the dust filtering member, so that dust and gas can enter the dust filtering member, and the dust is filtered in the dust filtering member. The gas passes through the dust filtering member and enters the gas filtering member, where the gas is purified and absorbed. The filtering mechanism improves the environmental protection of the embedding cassette marking machine.

3. By providing a heat dissipation mechanism inside the housing, heat generated by an internal heat mechanism is dissipated. The first air inlet, the second air inlet and the first air outlet form a first heat dissipation duct, and heat generated by the display control screen and the power supply assembly is discharged from the first heat dissipation duct. The third air inlet and the second air outlet form a second heat dissipation duct, and heat generated by the laser is discharged from the second heat dissipation duct. The dual-duct heat dissipation system improves the heat dissipation effect of the embedding cassette marking machine.

4. By providing a stopping block at the bottom end of the slideway and a buffer block at the bottom of the slideway relatively adjacent to the stopping block, the embedding cassette is first stopped and buffered by the buffer block, and then slides down to the stopping block. The buffer block prevents the embedding cassette from sliding directly to the stopping block, and the buffer block slows down the speed at which the embedding cassette slides down to the stopping block, so as to prevent the embedding cassette from rushing out of the stopping block and being separated from the slideway due to excessive speed.

5. By providing a first inclined portion on the buffer block, the embedding cassette cover can smoothly pass through the inclined surface of the buffer block, while the embedding cassette body is still stopped at the buffer block. The conjoined embedding cassette includes an embedding cassette body and an embedding cassette cover. During the sliding process of the conjoined embedding cassette on the slideway, the conjoined embedding cassette passes through the buffer block and reaches the bottom end of the slideway. The first inclined portion can enable the embedding cassette cover to slide smoothly without being stuck at the buffer block.

6. By providing the material-carrying rail on the side of the slideway relatively adjacent to the loading mechanism, the pushing mechanism pushes the embedding cassette into the material-carrying rail. The embedding cassettes are arranged in a forward order on the material-carrying rail, which is more in line with people's usage habits.

### BRIEF DESCRIPTION OF THE DRAWINGS

Embodiments of the present disclosure will now be explained in further detail by way of example with reference to the accompanying drawings.

FIG. 1 is a schematic diagram illustrating an overall structure of an embedding cassette marking machine according to one embodiment of the present disclosure.

FIG. 2 is a schematic diagram illustrating a partial structure of an embedding cassette marking machine according to one embodiment of the present disclosure.

FIG. 3 is a schematic diagram illustrating another partial structure of an embedding cassette marking machine according to one embodiment of the present disclosure.

FIG. 4 is a partial exploded view illustrating an embedding cassette marking machine according to one embodiment of the present disclosure.

FIG. 5 is a schematic diagram illustrating another partial structure of an embedding cassette marking machine according to one embodiment of the present disclosure.

FIG. 6 is a schematic structural diagram illustrating a conjoined embedding cassette according to one embodiment of the present disclosure.

FIG. 7 is a schematic diagram illustrating another partial structure of an embedding cassette marking machine according to one embodiment of the present disclosure.

FIG. 8 is a schematic diagram illustrating another partial structure of an embedding cassette marking machine according to one embodiment of the present disclosure.

FIG. 9 is a schematic diagram illustrating another partial structure of an embedding cassette marking machine according to one embodiment of the present disclosure.

FIG. 10 is a schematic diagram illustrating another partial structure of an embedding cassette marking machine according to one embodiment of the present disclosure.

FIG. 11 is a schematic diagram illustrating another partial structure of an embedding cassette marking machine according to one embodiment of the present disclosure.

FIG. 12 is another schematic diagram illustrating an overall structure of an embedding cassette marking machine according to one embodiment of the present disclosure.

### LIST OF REFERENCE SIGNS

101, housing; 1011, maintenance door; 1012, maintenance door sensor; 102, bottom plate; 103, frame; 20, feeding mechanism; 201, conveying assembly (conveying mechanism); 202, loading assembly (loading mechanism); 2021, loading box; 2022, transition plate (support plate); 2023, embedding cassette pressing block; 2024, second inclined portion; 2025, sliding shaft; 2026, third inclined portion; 2027, fourth baffle; 2028, blocking portion; 203, slideway assembly (sliding mechanism); 2031, slideway; 2032, stopping block (second block); 2033, buffer block (first block); 2034, first inclined portion; 2035, first baffle; 2036, second baffle; 2037, inlet; 2038, outlet; 2039, third baffle; 2040, anti-flying baffle; 2041, through hole; 30, laser marking mechanism; 301, marking member; 302, laser; 303, fan; 40, embedding cassette; 401, embedding cassette body; 402, embedding cassette cover; 403, protruding plate; 50, discharging mechanism; 501, pushing assembly (pushing mechanism); 5011, pushing block; 5012, first sensor; 5013, second sensor; 5014, light barrier; 5015, conveyor belt; 5016, motor; 502, material-carrying rail; 503, moving track; 504, limiting plate; 60, filtering mechanism; 601, dust filtering member; 602, gas filtering member; 603, first blower; 70, display mechanism; 701, display control screen; 702, power supply assembly; 80, heat dissipation mechanism; 801, first air inlet; 802, second air inlet; 803, third air inlet; 804, first air outlet; 805, second air outlet; 806, second blower.

### DETAILED DESCRIPTION

The technical solutions in embodiments of the present disclosure will be clearly and completely described below in conjunction with the accompanying drawings in embodiments of the present disclosure. Obviously, the described embodiments are part of embodiments of the present disclosure, rather than all of the embodiments. Based on the embodiments in the present disclosure, all other embodiments obtained by those having ordinary skill in the art without inventive efforts should fall within the protection scope of the present disclosure. It should be noted that all directional indications (such as up, down, left, right, front, rear, etc.) in the embodiments of the present disclosure are configured to explain the relative positional relationship, movement status, etc. between components in a specific posture. If the specific posture changes, the directional indication will also change accordingly.

embedding cassette marking machines in the related art can usually only mark embedding cassettes of one state type and have low levels of automation and intelligence.

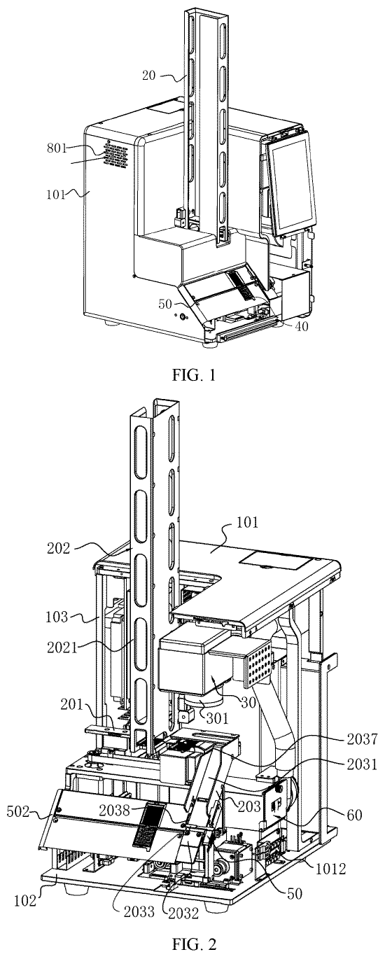

Referring to FIG. 1 and FIG. 2, an embedding cassette marking machine in an embodiment of the present disclosure includes a bottom plate 102, a frame 103, and a housing 101. The frame 103 is disposed on the bottom plate 102. The frame 103 and the bottom plate 102 provide a mounting base. The housing 101 is disposed on the frame 103 to protect an internal structure of the embedding cassette marking machine. A feeding mechanism 20 disposed in the housing 101 conveys an embedding cassette 40 to a lower side of a laser marking mechanism 30, and the laser marking mechanism 30 is configured to perform laser marking on the embedding cassette 40. Then, a discharging mechanism 50 pushes out the marked embedding cassette 40, so that a user can take the marked embedding cassette 40. In some examples, the feeding mechanism 20 may be partially or completely located outside the housing 101.

Referring to FIG. 2, the feeding mechanism 20 includes a conveying assembly 201, a loading assembly 202, and a slideway assembly 203. Specifically, the conveying assembly 201 is disposed on the frame 103 and corresponds to the loading assembly 202 to push the embedding cassette 40 on the loading assembly 202 to move. The slideway assembly 203 is disposed on a side of the loading assembly 202 that is relatively far away from the conveying assembly 201. The conveying assembly 201 pushes the embedding cassette 40 on the loading assembly 202 to move into the slideway assembly 203.

Specifically, the slideway assembly 203 includes a slideway 2031. The slideway 2031 corresponds to the loading assembly 202, and there is a certain distance between a highest position and a lowest position of the slideway 2031. The conveying assembly 201 pushes the embedding cassette 40 on the loading assembly 202 from an inlet 2037 of the slideway 2031 to the highest position of the slideway 2031. Under the action of gravity, the embedding cassette 40 slides along the slideway 2031 to the lowest position of the slideway 2031. The slideway 2031 is inclined relative to the bottom plate 102, that is, the slideway 2031 and a horizontal surface can form an angle greater than 0 degrees. An outlet 2038 of the slideway 2031 is provided adjacent to a bottom of the slideway 2031, and the outlet 2038 and inlet 2037 are located on the same side of the slideway 2031. The discharging mechanism 50 pushes the marked embedding cassette 40 out of the outlet.

Referring to FIGS. 2 to 9, in an embodiment of the present disclosure, the embedding cassette marking machine includes a conveying mechanism 201, a loading mechanism 202 and a pushing mechanism 501 arranged to correspond to the conveying mechanism 201. The conveying mechanism 201 is also referred to as a conveying assembly 201, the loading mechanism 202 is also referred to as a loading assembly 202, and the pushing mechanism 501 is also referred to as a pushing assembly 501. The loading mechanism 202 holds a conjoined embedding cassette 40 with an embedding cassette cover 402 opened or closed, or an embedding cassette body 401. The conveying mechanism 201 pushes the embedding cassette 40 (hereinafter, the embedding cassette 40 includes the embedding cassette cover 402 and the embedding cassette body 401) to move to the sliding mechanism 203. The sliding mechanism 203 is also referred to as a slideway assembly 203. The sliding mechanism 203 includes a slideway 2031. When the embedding cassette 40 slides down the slideway 2031, a first baffle 2035 and a second baffle 2036 respectively disposed on opposite sides of the slideway 2031 can prevent the embedding cassette 40 from being separated from the slideway 2031. A stopping block 2032 is further disposed at a bottom end of the slideway 2031 to stop the embedding cassette 40 at the bottom end of the slideway 2031. The pushing mechanism 501 includes a buffer block 2033, and the buffer block 2033 is disposed at the bottom of the slideway 2031 relatively adjacent to the stopping block 2032. The embedding cassette 40 first reaches the buffer block 2033, and the embedding cassette is marked when the embedding cassette reaches the buffer block 2033, and then moves to separate from the slideway 2031, and then the embedding cassette 40 slides down to the stopping block 2032. Thus, the buffer block 2033 reduces the speed at which the embedding cassette 40 slides down to the stopping block 2032, preventing the embedding cassette 40 from being separated from the slideway 2031 due to excessive sliding speed. Specifically, a pushing block 5011 can drive the buffer block 2033 to move onto the slideway 2031, and the buffer block 2033 is located on a side of the stopping block 2032 adjacent to the inlet 2037. The buffer block 2033 is configured to stop and buffer the embedding cassette 40. The pushing block 5011 can also drive the buffer block 2033 to move away from the slideway 2031, so that the embedding cassette 40 slides down to the stopping block 2032. Referring to FIG. 9, the buffer block 2033 may be moved to the outside of the slideway 2031.

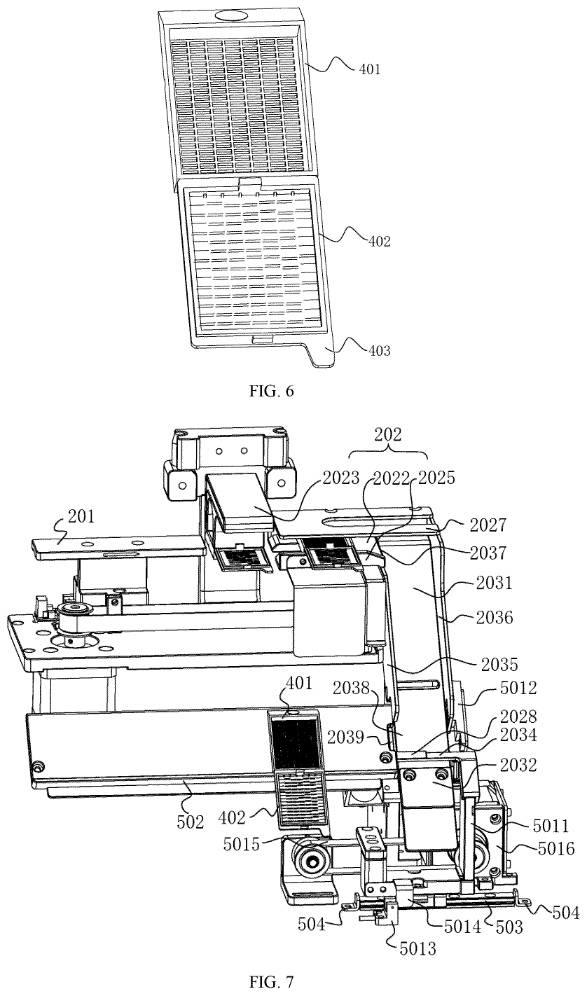

Referring to FIG. 6, the conjoined embedding cassette 40 includes an embedding cassette body 401 and an embedding cassette cover 402. Specifically, the embedding cassette body 401 is connected to the embedding cassette cover 402, and the embedding cassette cover 402 may be separated from the embedding cassette body 401. There are three states when a user uses the embedding cassette 40. One state is the conjoined embedding cassette 40 in which the embedding cassette cover 402 is connected to the embedding cassette body 401 and is open; another state is the conjoined embedding cassette 40 in which the embedding cassette cover 402 covers the embedding cassette body 401; yet another state is the embedding cassette 40 with only the embedding cassette body 401. Referring to FIG. 6, in the conjoined embedding cassette 40, in order to facilitate opening of the embedding cassette cover 402, a protruding plate 403 is usually provided on the embedding cassette cover 402 to facilitate opening.

Referring to FIGS. 7 to 9, in an embodiment, half of the buffer block 2033 is provided with a first inclined portion 2034 that forms a preset angle with the slideway 2031, and the other half of the buffer block is provided with a blocking portion 2028 that is parallel to the slideway 2031. A side of the first inclined portion 2034 that is relatively adjacent to the stopping block 2032 is higher than another side that is relatively far away from the stopping block 2032. The height of the blocking portion 2028 is consistent with the height of a highest position of the first inclined portion 2034. When the embedding cassette 40 slides down to the buffer block 2033, the blocking portion 2028 blocks the embedding cassette body 401, and the embedding cassette cover 402 smoothly slides down to the bottom end of the slideway 2031 through the first inclined portion 2034. The buffer block 2033 provided with the first inclined portion 2034 and the blocking portion 2028 can not only stop the embedding cassette body 401, but also enable the embedding cassette cover 402 to slide down smoothly, and is suitable for the embedding cassette 40 of various states and types.

Specifically, referring to FIGS. 5 to 7, when the opened conjoined embedding cassette 40 slides down the slideway 2031, the embedding cassette cover 402 faces downward, and the embedding cassette cover approaches the buffer block 2033 first. When sliding down, the embedding cassette cover 402 needs to pass over the buffer block 2033 first, and then the embedding cassette body 401 abuts against the buffer block 2033. Since the protruding plate 403 is at an end portion of the embedding cassette cover 402, the protruding plate 403 reaches the buffer block 2033 first. At this time, as long as the protruding plate 403 can pass over the buffer block 2033, the embedding cassette cover 402 can also pass over the buffer block 2033 smoothly.

Additionally, when the conjoined embedding cassette 40 slides down, the protruding plate 403 is located on the slideway 2031 adjacent to the second baffle 2036. In order to better enable the protruding plate 403 to pass over the buffer block 2033, when the buffer block 2033 moves to a position overlapping with the slideway 2031, the first inclined portion 2034 on the buffer block is located at a position adjacent to the second baffle 2036, and the blocking portion 2028 is located at a position adjacent to the first baffle 2035, thereby allowing the protruding plate 403 to correspondingly pass over the first inclined portion 2034. The first inclined portion 2034 is inclined and includes an inclined surface, so that an inclined surface of the first inclined portion 2034 can avoid contact with the protruding plate 403 and the embedding cassette cover 402 as much as possible, allowing the protruding plate 403 and the embedding cassette cover 402 to pass over more smoothly.

It is understandable that when the conjoined embedding cassette 40 is in a closed state, or when a user uses an embedding cassette 40 with only the embedding cassette body 401, there is no need to consider the problem of the embedding cassette cover 402 passing over, and it is sufficient for the buffer block to stop the embedding cassette body 401. Therefore, the embedding cassette marking machine in embodiments of the present disclosure can be adapted to embedding cassettes 40 of different types and states. However, embedding cassette marking machines in related art can usually only use an embedding cassette 40 of one state type, which has certain limitations. When it is necessary to use the embedding cassette 40 of another state type, it is necessary to purchase another corresponding embedding cassette marking machine. Since the overall shapes of the embedding cassette 40 in different states are different, when the embedding cassette 40 of the embedding cassette marking machine are loaded and unloaded, a stopping apparatus cannot stop multiple types of embedding cassettes 40 at the same time.

One end of the slideway 2031 relatively adjacent to the ground is provided with a first block 2033 and a second block 2032. The first block 2033 is also referred to as a buffer block 2033, and the second block 2032 is also referred to as a stopping block 2032. Specifically, the first block 2033 is in transmission connection with the discharging mechanism 50. The first block 2033 can be driven by the discharging mechanism 50 to move back and forth in a direction away from or adjacent to the outlet 2038. The second block 2032 is disposed at a lowest position of the slideway 2031, and the first block 2033 is disposed at a position on the slideway 2031 that is higher than the second block 2032, that is, a position closer to the inlet 2037 of the slideway 2031. The first block 2033 and the second block 2032 correspond to the outlet 2038 of the slideway 2031.

The embedding cassette 40 slides down from the highest position of the slideway 2031 and first reaches the first block 2033. The first block 2033 stops the embedding cassette 40, and the laser marking mechanism 30 marks the embedding cassette 40. After the embedding cassette 40 is marked, the discharging mechanism 50 drives the first block 2033 to move away from the outlet 2038 of the slideway 2031 until the first block 2033 does not overlap with the slideway 2031, and the embedding cassette 40 slides down to the second block 2032. At this time, the discharging mechanism 50 drives the first block 2033 to move toward the slideway, and the first block 2033 abuts against the embedding cassette 40 and pushes the embedding cassette 40 to move away from the outlet 2038 of the slideway 2031 until the embedding cassette 40 is separated from the slideway 2031.

Referring to FIG. 2, FIG. 5 and FIG. 7, the slideway 2031 includes an inlet 2037 of the slideway 2031 corresponding to the loading mechanism 202. Specifically, the conveying mechanism 201 pushes the embedding cassette 40 to move through the inlet 2037 of the slideway 2031 and to the slideway 2031. The first baffle 2035 is disposed on a side of the slideway 2031 where the inlet 2037 of the slideway 2031 is provided, and the second baffle 2036 is disposed on another side of the slideway 2031. Both the first baffle 2035 and the second baffle 2036 can prevent the embedding cassette 40 from being separated from the slideway 2031.

An outlet 2038 of the slideway 2031 is also provided adjacent to the bottom of the slideway 2031. Specifically, the outlet 2038 of the slideway 2031 is provided on the slideway 2031 on the same side as the inlet 2037 of the slideway 2031. The first baffle 2035 can block the slideway 2031 except for an inlet 2037 of the slideway and an outlet of the slideway, that is, the first baffle 2035 will not block the inlet 2037 and the outlet 2038.

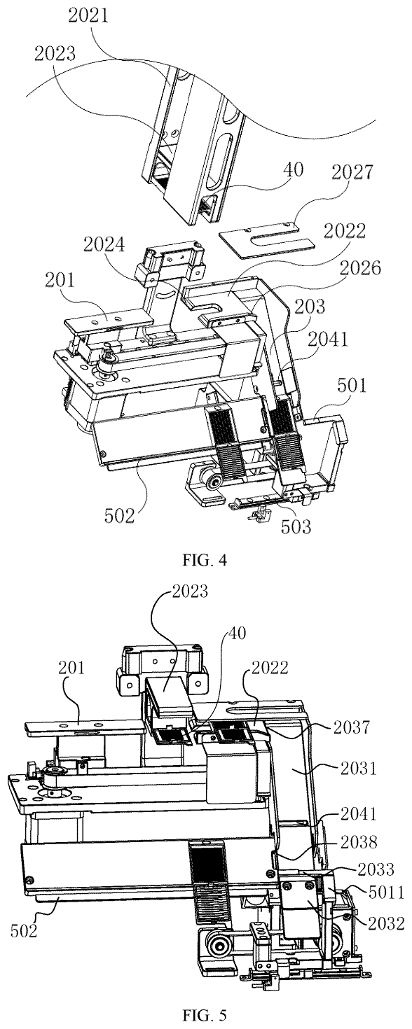

Referring to FIG. 4, FIGS. 7 to 9, the pushing mechanism 501 also includes a pushing block 5011, a conveyor belt 5015 and a motor 5016. Specifically, the pushing block 5011 is in transmission connection with the motor 5016 via the conveyor belt 5015. The pushing block 5011 is movably disposed on an opposite side corresponding to the outlet 2038 of the slideway 2031. The pushing block 5011 is connected to the buffer block 2033. The pushing block 5011 can move toward or away from the outlet 2038 of the slideway 2031. During the movement of the pushing block 5011, the buffer block 2033 is driven to move toward or away from the outlet 2038 of the slideway 2031.

when the embedding cassette 40 slides down and the pushing block 5011 drives the buffer block 2033 to move toward the outlet 2038 of the slideway 2031, the buffer block 2033 gradually overlaps with the slideway 2031, and the embedding cassette 40 slides down to the buffer block 2033. Then, when the pushing block 5011 drives the buffer block 2033 to move away from the outlet 2038 of the slideway 2031, the buffer block 2033 gradually separates from the slideway 2031, and the embedding cassette 40 continues to slide down to the stopping block 2032. The pushing block 5011 then drives the buffer block 2033 to move toward the outlet 2038 of the slideway 2031, and the buffer block 2033 pushes the embedding cassette 40 to separate from the slideway 2031 to a designated position.

A moving track 503 is provided at a lower side of the pushing block 5011, and the pushing block 5011 moves on the moving track 503. The length of the moving track 503 limits the moving distance and direction of the pushing block 5011.

Specifically, in an embodiment, two ends of the moving track 503 are respectively provided with limiting plates 504 to prevent the pushing block 5011 from being separated from the moving track 503 and causing structural dislocation during movement on the moving track 503.

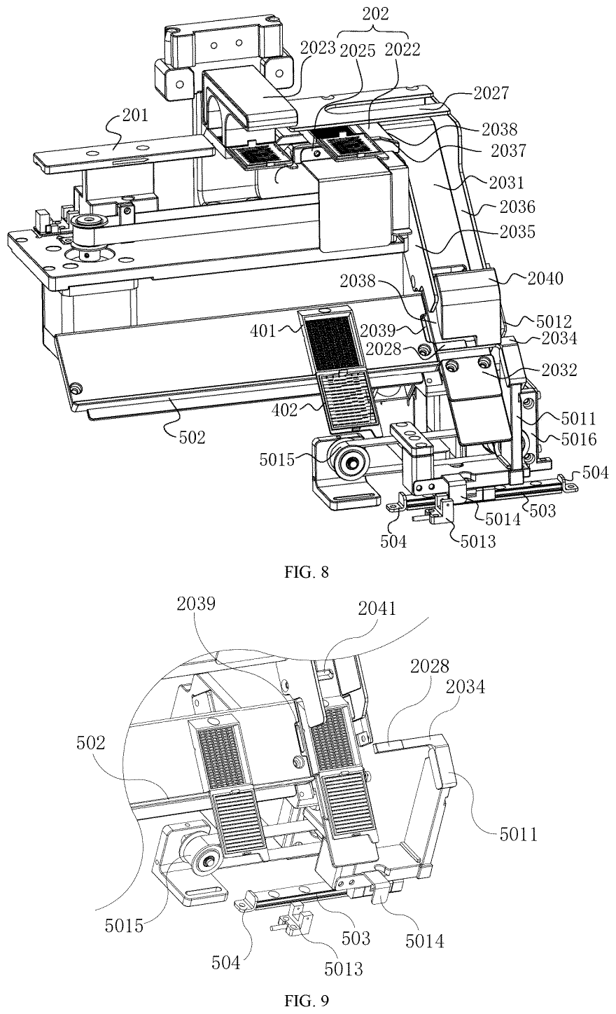

Referring to FIG. 8 and FIG. 9, the pushing mechanism 501 also includes a first sensor 5012, and a blocking mechanism also includes a third baffle 2039. Specifically, the first sensor 5012 is disposed on a side of the slideway 2031 relatively away from the outlet 2038 of the slideway 2031, and the third baffle 2039 is communicatively connected with the first sensor 5012.

When the pushing block 5011 starts to move toward the outlet 2038 of the slideway 2031, the third baffle 2039 rises to block the outlet 2038 of the slideway 2031 to prevent the embedding cassette 40 from being separated from the slideway 2031 without being marked. That is, when the embedding cassette 40 slides down from the slideway 2031, the embedding cassette 40 will be blocked and limited by the buffer block 2033 driven by the pushing block 5011 and the rising third baffle 2039.

In some examples, the embedding cassette marking machine includes an electromagnet, and the third baffle 2039 is connected to the electromagnet. When the electromagnet is powered on, the third baffle 2039 is lowered to open the outlet 2038 of the slideway 2031. When the electromagnet is powered off, the third baffle 2039 rises to block the outlet 2038 of the slideway 2031.

Referring to FIG. 5 and FIG. 9, the pushing mechanism 501 also includes a second sensor 5013 and a light barrier 5014. Specifically, the light barrier 5014 is disposed on the pushing block 5011. When the pushing block 5011 moves in the direction toward the outlet 2038 of the slideway 2031 until the buffer block 2033 overlaps with the slideway 2031, the light barrier 5014 contacts the second sensor 5013, then the pushing block 5011 stops moving, and the buffer block 2033 pauses on the slideway 2031. After the embedding cassette 40 stuck on the slideway 2031 is marked, the third baffle 2039 is lowered, and the buffer block 2033 moves in the direction away from the outlet 2038 of the slideway 2031 driven by the pushing block 5011, and the marked embedding cassette 40 slides down to the stopping block 2032.

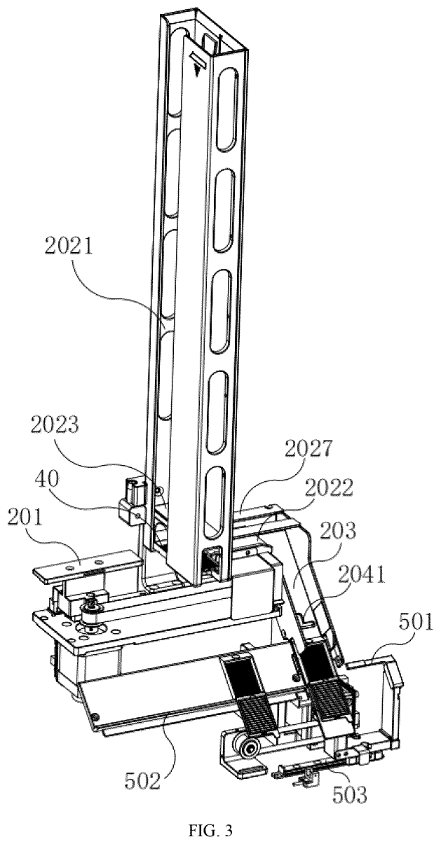

The material-carrying rail 502 is configured to receive the marked embedding cassette 40. Specifically, when the embedding cassette 40 slides down to the buffer block 2033, marking starts. After marking is completed, the motor 5016 drives the pushing block 5011 to move on the moving track 503 along the direction toward the outlet 2038 of the slideway 2031, and the buffer block 2033 connected to the pushing block 5011 also moves along the direction toward the outlet 2038 of the slideway 2031 to push the embedding cassette 40 to move to the material-carrying rail 502 and be sorted in sequence. Since the marked embedding cassettes 40 are pushed onto the material-carrying rail 502 in sequence, for the convenience of description, an end of the material-carrying rail 502 away from the pushing assembly 501 is defined as a track end. Referring to FIG. 3, when the material-carrying rail 502 is loaded with a plurality of embedding cassettes 40, the embedding cassette 40 marked first is located at a position adjacent to the track end, and the embedding cassette 40 marked later is located at a position adjacent to the pushing assembly 501. Usually, serial numbers marked on the embedding cassettes 40 are in ascending order. Thus, the embedding cassette 40 taken by a staff adjacent to the track end is also the embedding cassette 40 with a smaller serial number.

When the embedding cassette 40 slides down to the buffer block 2033 and the first sensor 5012 detects the embedding cassette 40, marking starts. After marking is completed, the third baffle 2039 moves downward to open the outlet 2038 of the slideway 2031. The pushing block 5011 moves in the direction away from the outlet 2038 of the slideway 2031, the buffer block 2033 gradually separates from the slideway 2031, and the marked embedding cassette 40 slides down to the stopping block 2032. Then the pushing block 5011 moves in the direction toward the outlet 2038 of the slideway 2031, and the buffer block 2033 pushes the embedding cassette 40 through the outlet 2038 of the slideway 2031 to the material-carrying rail 502.

Referring to FIG. 8, the blocking mechanism further includes an anti-flying baffle 2040. Specifically, the anti-flying baffle 2040 is disposed at an upper side of a position on the slideway 2031 where the embedding cassette 40 is retained at the stopping block 2032. The anti-flying baffle 2040 is connected to the first baffle 2035 and the second baffle 2036. The anti-flying baffle 2040 can further prevent the embedding cassette 40 from being separated from the slideway 2031 when sliding down to the buffer block 2033. When the embedding cassette 40 is thrown upward out of the slideway 2031, the anti-flying baffle 2040 can block the embedding cassette 40 from being separated from the slideway 2031.

Referring to FIG. 3 and FIG. 4, the loading mechanism 202 includes a loading slot and a support plate 2022 arranged to correspond to the loading slot. The loading slot is also referred to as a loading box 2021. Specifically, the loading slot and the support plate 2022 are disposed between the conveying mechanism 201 and the slideway 2031. The loading slot is disposed on a side relatively adjacent to the conveying mechanism 201. The support plate 2022 is disposed on a side relatively adjacent to the slideway 2031. The conveying mechanism 201 pushes the embedding cassettes 40 in the loading slot to move to the support plate 2022 and enter the slideway 2031 through the inlet 2037 of the slideway 2031.

The blocking mechanism further includes a fourth baffle 2027. Specifically, the fourth baffle 2027 is disposed on an upper side of the support plate 2022, and the support plate 2022 is also referred to as a transition plate 2022. The embedding cassette 40 is located in a space formed by the support plate 2022 and the fourth baffle 2027. The fourth baffle 2027 can further prevent the embedding cassette 40 from being separated from the support plate 2022 and the slideway 2031.

Referring to FIG. 3 and FIG. 4, in an embodiment, the loading assembly 202 includes a loading box 2021 and a transition plate 2022. The transition plate 2022 is disposed on a side of the loading box 2021 relatively away from the conveying assembly 201, and a side of the transition plate 2022 relatively away from the loading box 2021 corresponds to the inlet 2037 of the slideway 2031. An embedding cassette pressing block 2023 is disposed in the loading box 2021. The embedding cassette 40 is light in weight, and the embedding cassette pressing block 2023 can tightly press the embedding cassette 40 in the loading box 2021, so that the conveying assembly 201 can be docked with the embedding cassette 40 more accurately to push the embedding cassette 40 to move toward the transition plate 2022. After being pushed out of the loading box 2021, the embedding cassette 40 first passes through the transition plate 2022 and then enters the slideway 2031 to prevent the embedding cassette 40 from being stuck during movement, making the feeding process of the embedding cassette 40 smoother and improving the fluency of embedding and feeding. Specifically, a plurality of embedding cassettes 40 are stacked in the loading box 2021, and the embedding cassette pressing block 2023 is placed on top of the uppermost embedding cassette 40, so that the plurality of embedding cassettes 40 below can be pressed tightly. When the bottommost embedding cassette 40 is sent to the transition plate 2022, the number of embedding cassettes 40 in the loading box 2021 decreases in sequence, and the embedding cassette pressing block 2023 is also gradually lowered.

In an embodiment, a second inclined portion 2024 is disposed on a side of the support plate 2022 adjacent to the conveying mechanism 201. The height of the side of the second inclined portion 2024 relatively adjacent to the conveying mechanism 201 is lower than the height of a side of the second inclined portion 2024 relatively away from the conveying mechanism 201. The second inclined portion 2024 can make the embedding cassette 40 move from the loading slot to the support plate 2022 more smoothly, and it is not easy to be stuck at a transition region between the loading slot and the support plate 2022.

A sliding shaft 2025 is provided on the support plate 2022. Specifically, a third inclined portion 2026 is provided at an end of the sliding shaft 2025 adjacent to the inlet 2037 of the slideway 2031. The height of a side of the third inclined portion 2026 relatively adjacent to the slideway 2031 is lower than the height of a side of the third inclined portion 2026 relatively away from the slideway 2031. The conveying mechanism 201 pushes the embedding cassette 40 to move from the loading slot to the support plate 2022, and the embedding cassette 40 passes through the sliding shaft 2025 during the process of moving from the support plate 2022 to the slideway 2031. The third inclined portion 2026 at the end of the sliding shaft 2025 adjacent to the inlet 2037 of the slideway 2031 makes it easier for the embedding cassette 40 to transition to the slideway 2031 under the action of gravity.

The implementation principle of structures such as the stopping block 2032 provided in the present disclosure is as follows: By providing the stopping block 2032 at the bottom end of the slideway 2031 and providing the buffer block 2033 at the bottom of the slideway 2031 relatively adjacent to the stopping block 2032, the embedding cassette 40 is first stopped and buffered by the buffer block 2033, and then slides down to the stopping block 2032. The buffer block 2033 prevents the embedding cassette 40 from sliding directly down to the stopping block 2032, and the buffer block 2033 slows down the speed at which the embedding cassette 40 slides down to the stopping block 2032, so as to prevent the embedding cassette 40 from rushing out of the stopping block 2032 and being separated from the slideway 2031 due to excessive speed. The buffer block 2033 is provided with a first inclined portion 2034, so that the embedding cassette cover 402 can pass through an inclined surface of the buffer block 2033, while the embedding cassette body 401 is still stopped at the buffer block 2033. The conjoined embedding cassette 40 includes an embedding cassette body 401 and an embedding cassette cover 402. During the sliding process of the conjoined embedding cassette 40 on the slideway 2031, the conjoined embedding cassette 40 passes through the buffer block 2033 and reaches the bottom end of the slideway 2031. The first inclined portion 2034 enables the embedding cassette cover 402 to slide smoothly without being stuck at the buffer block 2033.

After the plastic embedding cassette 40 is laser marked, dust and pungent odor will be generated. If the dust and gas are not treated and are directly released into the air, there will be unpleasant and toxic odors and a large amount of dust in the surrounding air. Inhaling the dust and toxic gases in the air is harmful to human health. However, existing filtering apparatuses in related art usually have only a single filtering structure, which is easily clogged during use and has poor filtering efficiency.

Referring to FIG. 2, in an embodiment, the embedding cassette marking machine further includes a filtering mechanism 60. The slideway assembly 203 is provided with a marking workstation, and the marking workstation is located at an orthographic projection of the laser marking mechanism. The laser marking mechanism 30 marks the embedding cassette 40 that slides down to the marking workstation, that is, the corresponding position of the embedding cassette is engraved by laser. The filtering mechanism 60 is in communication with the marking workstation to filter dust and gas at the marking workstation. Thus, the marking workstation is located at the orthographic projection of the laser marking mechanism, enabling the laser marking mechanism to accurately mark the embedding cassette 40. Since dust and odor are generated during the laser engraving process, the filtering mechanism 60 in the embodiment is in communication with the marking workstation, so that dust and gas can be filtered as soon as possible to avoid polluting the external environment. In some examples, the marking workstation may be located directly below the laser marking mechanism.

Referring to FIGS. 9 to 11, the embedding cassette marking machine further includes a filtering mechanism 60 for filtering dust and gas. Specifically, the filtering mechanism 60 includes a dust filtering member 601, a gas filtering member 602, and a first blower 603, and the laser marking mechanism 30 includes a marking member 301 and a laser 302. Since dust and pungent odor gas are generated when the laser marking mechanism 30 marks the embedding cassette 40, the slideway 2031 is provided with a through hole 2041 overlapping with an orthographic projection of the marking member 301, that is, the marking workstation of the slideway 2031 is provided with a through hole 2041. The dust filtering member 601 is in communication with the through hole 2041. The dust filtering member 601 is a hollow box, and asbestos capable of filtering dust is disposed in the dust filtering member 601. The dust and pungent odor gas generated after the embedding cassette 40 is marked enter the dust filtering member through the through hole 2041, the dust is filtered in the dust filtering member, and the gas can pass through the asbestos inside the dust filtering member.

The first blower 603 is in communication with the dust filtering member 601 and is disposed on a side of the dust filtering member 601 relatively away from the through hole 2041. When the first blower 603 is started, negative pressure is generated inside the dust filtering member 601, and dust and gas are sucked into the dust filtering member 601.

The gas filtering member 602 is in communication with the dust filtering member 601. Gas passes through the asbestos inside the dust filtering member 601 and is transported into the gas filtering member 602 under the action of the first blower. The gas filtering member 602 is a hollow sealed box with activated carbon inside, and the activated carbon can adsorb and purify pungent odor gas. When the gas enters the gas filtering member 602, the activated carbon can purify the gas, thereby improving the environmental protection level of the marking process of the embedding cassette marking machine.

The implementation principle of the filtering mechanism 60 provided in the present disclosure is: By providing the dust filtering member 601 at the marking position of the embedding cassette 40, the first blower 603 is started, and the dust and gas generated after laser marking of the embedding cassette 40 are sucked into the dust filtering member 601, and the dust is adsorbed by the dust filtering member 601. The gas then enters the gas filtering member 602. The gas filtering member 602 purifies toxic and unpleasant gas. The filtering mechanism 60 is more targeted and improves the overall filtering effect.

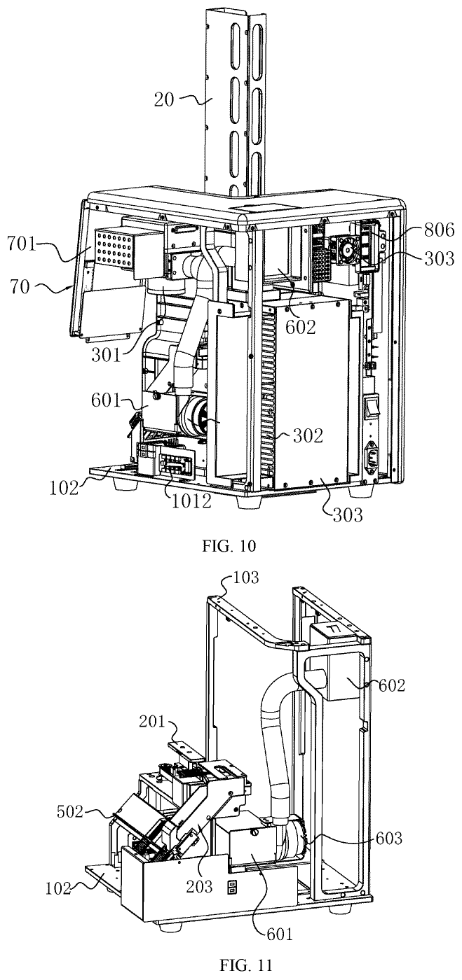

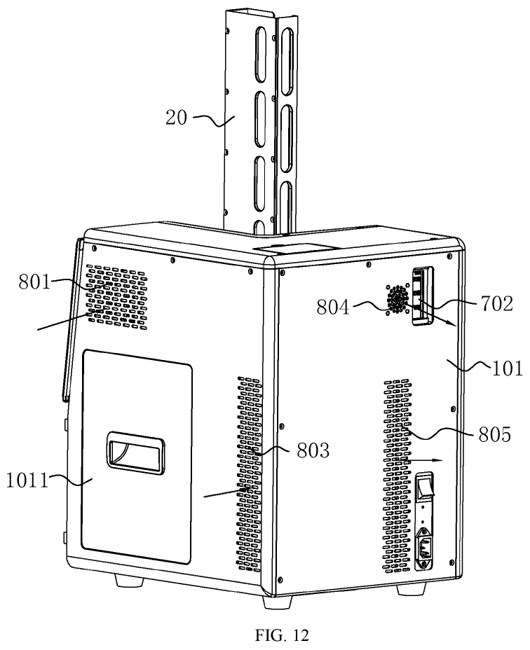

Referring to FIG. 2 and FIG. 10, the laser marking mechanism 30 includes a marking member 301 and a laser 302. The marking member 301 is connected to the laser 302. The marking member 301 is disposed on an upper side of the slideway assembly 203 to mark the embedding cassette 40 that slides down to the slideway assembly 203. The laser 302 is started so that the marking member can perform laser marking. The marking member is disposed on an upper side of the first block 2033 and can mark the embedding cassette 40 accordingly. The marking member 301 is an optical device.

The discharging mechanism 50 includes a pushing assembly 501 and a material-carrying rail 502. Specifically, the pushing assembly 501 includes a pushing block 5011, and the pushing block 5011 is in transmission connection with the first block 2033. The pushing block 5011 can drive the first block 2033 to move back and forth in a direction toward or away from the material-carrying rail 502. The material-carrying rail 502 is disposed on a side of the slideway 2031 relatively away from the pushing block 5011, and corresponds to the outlet 2038 of the slideway 2031. The pushing block 5011 can drive the first block 2033 to push the embedding cassette 40 toward the outlet 2038 of the slideway 2031, and the embedding cassette 40 gradually separates from the slideway 2031 and gradually overlaps with the material-carrying rail 502. When the embedding cassette 40 is completely separated from the slideway 2031, the embedding cassette 40 completely overlaps with the material-carrying rail 502.

Referring to FIG. 10, the embedding cassette marking machine further includes a display mechanism 70. Specifically, the display mechanism 70 includes a display control screen 701 and a power supply assembly 702. The display control screen 701 is electrically connected to the power supply assembly 702. After the display control screen 701 is connected to the power supply assembly 702, a user can set the number of embedding cassettes 40 to be marked via the display control screen 701, simplifying the process of the user using the embedding cassette marking machine, facilitating user's operation, and providing great convenience for the user.

Referring to FIG. 1, the embedding cassette marking machine further includes a heat dissipation mechanism 80 for dissipating heat from internal heat-generating components. Specifically, the heat dissipation mechanism 80 includes a first air inlet 801, a second air inlet 802, a third air inlet 803, a first air outlet 804, a second air outlet 805, and a second blower 806. The first air inlet 801 is provided on a side of the housing 101 adjacent to the display control screen 701, the second air inlet 802 is provided on a side of the housing 101 adjacent to the power supply assembly 702, and the first air outlet 804 is provided with the second blower 806. The second blower 806 is started to draw air out of the housing 101, thus, negative pressure is generated inside the housing 101. Airflow enters the housing 101 from the first air inlet 801, passes through the display control screen and takes away heat generated by the display control screen, and the heat is discharged from the first air outlet 804. At the same time, airflow enters the housing 101 from the second air inlet 802, passes through the power supply assembly 702 and takes away heat generated by the power supply assembly 702, and the heat is discharged from the first air outlet 804. The first air inlet 801, the second air inlet 802, and the first air outlet 804 form a first heat dissipation duct. Referring to FIG. 10, a fan 303 is disposed in the laser 302. When the laser 302 is operating, the fan 303 also operates synchronously to dissipate heat from the laser 302. When the fan 303 is operating, convection is formed between the third air inlet 803 and the second air outlet 805, and airflow enters the housing 101 from the third air inlet 803, passes through the laser 302 and takes away heat, and the heat is discharged from the second air outlet 805.

The housing 101 includes a maintenance door 1011. Specifically, the maintenance door 1011 is detachably disposed on the housing 101 and is arranged adjacent to the slideway assembly 203. A user can open the maintenance door 1011 to inspect and maintain the interior of the embedding cassette marking machine. When the dust filtering member is clogged, the user can open the maintenance door 1011 to replace or clean the dust filtering member, preventing the dust filtering member from being clogged and the filtering mechanism 60 from failing to work properly.

An operating method of an embedding cassette marking machine includes the following steps:

Provide a third baffle 2039, which is movably disposed at an outlet 2038 of a slideway 2031. The first block 2033 gradually overlaps with the slideway 2031 under the drive of a pushing block 5011. The third baffle 2039 rises to block the outlet 2038 of the slideway 2031. Actuate a conveying assembly 201 to push an embedding cassette 40 in the loading assembly 202 to move to the slideway assembly 203. The embedding cassette 40 slides down the slideway 2031 to the first block 2033.

Operate a marking member 301 to perform laser marking on the embedding cassette 40.

Lower The third baffle 2039 is lowered to open the outlet 2038 of the slideway 2031, and actuate the pushing block 5011 to move the first block 2033 away from the slideway 2031.

Allow the embedding cassette 40 to slide down to a second block 2032, and drive the pushing block 5011 to move the first block 2033 toward the slideway 2031 to push the embedding cassette 40 from the outlet 2038 of the slideway 2031 to a material-carrying rail 502.

In the step of performing laser marking on embedding cassettes 40, the first blower 603 is started, and the dust filtering member filters dust. If the rotation speed of the first blower 603 decreases, it indicates that the dust filtering member is blocked; the second blower 806 is started, and heat from the display control screen 701 and the power supply assembly 702 is discharged from the first air outlet 804; the fan 303 is started, and heat from the laser 302 is discharged from the second air outlet 805.

A maintenance door sensor 1012 is provided on an inner side of the maintenance door 1011. If the maintenance door 1011 is detached from the housing 101, the embedding cassette marking machine stops operating. When the maintenance door 1011 is mounted on the housing 101, the embedding cassette marking machine can operate normally, preventing maintenance personnel from being injured if the embedding cassette marking machine is started while the maintenance door 1011 is detached from the housing 101 during maintenance, thereby improving safety performance.

The implementation principle of the embedding cassette marking machine and the operating method provided in the present disclosure is: By providing a conveying assembly 201 corresponding to the loading assembly 202, the conveying assembly 201 can push the embedding cassette 40 in the loading assembly 202 to move to the slideway 2031. The embedding cassette 40 slides down the slideway 2031 to the first block 2033, which is also referred to as the buffer block 2033. At this time, the embedding cassette marking machine performs laser marking on the embedding cassette 40. After the laser marking of the embedding cassette 40 is completed, the pushing block 5011 drives the first block 2033 to move away from the slideway 2031 until the first block 2033 is completely separated from the slideway 2031, and the embedding cassette 40 slides down to the second block 2032, which is also referred to as the stopping block 2032. The pushing block 5011 drives the first block 2033 to move toward the slideway 2031, and the embedding cassette 40 gradually separates from the slideway 2031. When the first block 2033 completely overlaps with the slideway 2031, the embedding cassette 40 is completely pushed out of the slideway 2031 and enters the material-carrying rail 502.

Although the present disclosure has been specifically described above in conjunction with the accompanying drawings and embodiments, it should be understood that the above description does not limit the present disclosure in any form. Those having ordinary skill in the art can make modifications and variations to the present disclosure as needed without departing from the essential spirit and scope of the present disclosure, and these modifications and variations all fall within the scope of the present disclosure.

What is claimed is:

1. An embedding cassette marking machine, comprising:
a housing;
a feeding mechanism disposed on the housing, the feeding mechanism comprising a conveying assembly, a loading assembly, and a slideway assembly, the conveying assembly being arranged to correspond to the loading assembly, the loading assembly being arranged to correspond to an inlet of the slideway assembly, the conveying assembly being configured to push an embedding cassette on the loading assembly to move toward the inlet of the slideway assembly;
a laser marking mechanism for marking the embedding cassette that slides down to the slideway assembly; and
a discharging mechanism comprising a pushing assembly and a material-carrying rail, the material-carrying rail being arranged to correspond to the pushing assembly, the pushing assembly comprising a pushing block, the pushing block being configured to reciprocate toward or away from the material-carrying rail, so as to push the marked embedding cassette to the material-carrying rail.

2. The embedding cassette marking machine according to claim 1, wherein the slideway assembly comprises a slideway, a stopping block is disposed at a bottom end of the slideway, and the stopping block is configured to stop the embedding cassette;
the pushing assembly further comprises a buffer block, the pushing block is connected to the buffer block, the pushing block is enabled to drive the buffer block to move to the slideway, and the buffer block is located on a side of the stopping block adjacent to the inlet, the buffer block being configured to stop and buffer the embedding cassette;
the pushing block is further configured to drive the buffer block to move away from the slideway, so that the embedding cassette slides down to the stopping block.

3. The embedding cassette marking machine according to claim 2, wherein the loading assembly holds a conjoined embedding cassette; the conjoined embedding cassette comprises an embedding cassette body and an embedding cassette cover; the embedding cassette body is connected to the embedding cassette cover; and
the buffer block is provided with a first inclined portion, so that the embedding cassette cover is enabled to pass through the buffer block, while the embedding cassette body is stopped at the buffer block.

4. The embedding cassette marking machine according to claim 2, wherein the material-carrying rail is disposed on a side of the slideway relatively adjacent to the loading assembly;
the pushing block is disposed on a side of the slideway relatively away from the loading assembly to push the embedding cassette to move toward the material-carrying rail.

5. The embedding cassette marking machine according to claim 2, wherein the slideway assembly comprises a blocking mechanism, the blocking mechanism comprises a first baffle and a second baffle, and the first baffle and the second baffle are respectively disposed on opposite sides of the slideway.

6. The embedding cassette marking machine according to claim 5, wherein the slideway further comprises an outlet corresponding to the material-carrying rail;
the blocking mechanism further comprises a third baffle communicatively connected with the pushing block; the third baffle is movably disposed at the outlet; and the third baffle is configured to regulate a sliding direction of the embedding cassette according to a moving direction of the embedding cassette.

7. The embedding cassette marking machine according to claim 6, wherein the pushing assembly further comprises a first sensor, the first sensor is disposed on a side of the slideway relatively away from the outlet, and the third baffle is communicatively connected with the first sensor.

8. The embedding cassette marking machine according to claim 5, wherein an anti-flying baffle is disposed on an upper side of the buffer block, and the anti-flying baffle is connected to the first baffle and the second baffle.

9. The embedding cassette marking machine according to claim 1, wherein the loading assembly comprises a loading box and a transition plate, the transition plate is disposed on a side of the loading box relatively away from the conveying assembly, and a side of the transition plate relatively away from the loading box corresponds to the inlet; and
an embedding cassette pressing block is disposed in the loading box.

10. The embedding cassette marking machine according to claim 1, wherein the embedding cassette marking machine further comprises a filtering mechanism;
the slideway assembly is provided with a marking workstation, the marking workstation is located at an orthographic projection of the laser marking mechanism, and the laser marking mechanism marks the embedding cassette that slides down to the marking workstation; and
the filtering mechanism is in communication with the marking workstation to filter dust and gas at the marking workstation.

11. The embedding cassette marking machine according to claim 10, wherein the filtering mechanism comprises a dust filtering member, a gas filtering member, and a first blower;
the marking workstation of the slideway assembly is provided with a through hole, the dust filtering member is arranged to correspond to the through hole, the first blower is disposed on a side of the dust filtering member relatively away from the through hole, and the gas filtering member is in communication with the dust filtering member.

12. The embedding cassette marking machine according to claim 1, wherein the laser marking mechanism comprises a marking member and a laser, the marking member is connected to the laser, and the marking member is disposed on an upper side of the slideway assembly to mark the embedding cassette that slides down to the slideway assembly.

13. The embedding cassette marking machine according to claim 12, wherein a fan is disposed in the laser.

14. The embedding cassette marking machine according to claim 1, wherein the embedding cassette marking machine further comprises a display mechanism, the display mechanism comprising a display control screen and a power supply assembly, the power supply assembly being electrically connected to the display control screen.

15. The embedding cassette marking machine according to claim 1, wherein the housing comprises a maintenance door, and the maintenance door is detachably disposed on the housing.

16. (canceled)

17. The embedding cassette marking machine according to claim 8, wherein the anti-flying baffle is disposed at an upper side of a position on the slideway where the embedding cassette is retained at the stopping block, and the anti-flying baffle is enabled to block the embedding cassette from being separated from the slideway.

18. The embedding cassette marking machine according to claim 2, wherein when the pushing block drives the buffer block to move to the slideway, the buffer block is located at a bottom of the slideway relatively adjacent to the stopping block, so that the embedding cassette first reaches the buffer block, and the laser marking mechanism is enabled to mark the embedding cassette that reaches the buffer block.

19. The embedding cassette marking machine according to claim 17, wherein when the pushing block drives the buffer block to separate from the slideway, the marked embedding cassette slides down to the stopping block.

20. The embedding cassette marking machine according to claim 3, wherein the first inclined portion forms a preset angle with the slideway, half of the buffer block is provided with the first inclined portion, and the other half of the buffer block is provided with a blocking portion that is parallel to the slideway.

21. An operating method of an embedding cassette marking machine, applied to the embedding cassette marking machine, the method comprising:
providing a third baffle movably disposed at an outlet of a slideway, a buffer block gradually overlapping with the slideway under the drive of a pushing block, and the third baffle rising to block the outlet of the slideway;
actuating a conveying assembly to push an embedding cassette in a loading assembly to move to a slideway assembly, such that the embedding cassette slides down the slideway to the buffer block;
operating a laser marking mechanism to perform laser marking on the embedding cassette;
lowering the third baffle to open the outlet of the slideway, and actuating the pushing block to move the buffer block away from the outlet of the slideway;
allowing the embedding cassette to slide down to a stopping block; and driving the pushing block to move the buffer block toward the outlet of the slideway to push the embedding cassette from the outlet of the slideway to a material-carrying rail;
wherein the embedding cassette marking machine comprises a housing; a feeding mechanism disposed on the housing, the feeding mechanism comprising a conveying assembly, a loading assembly, and a slideway assembly, the conveying assembly being arranged to correspond to the loading assembly, the loading assembly being arranged to correspond to an inlet of the slideway assembly, the conveying assembly being configured to push an embedding cassette on the loading assembly to move toward an inlet of the slideway assembly; the laser marking mechanism for marking the embedding cassette that slides down to the slideway assembly; and a discharging mechanism comprising a pushing assembly and a material-carrying rail, the material-carrying rail being arranged to correspond to the pushing assembly, the pushing assembly comprising a pushing block, the pushing block being configured to reciprocate toward or away from the material-carrying rail, so as to push the marked embedding cassette to the material-carrying rail;
wherein the slideway assembly comprises the slideway, the stopping block is disposed at a bottom end of the slideway, and the stopping block is configured to stop the embedding cassette; the pushing assembly further comprises the buffer block, the pushing block is connected to the buffer block, the pushing block is enabled to drive the buffer block to move to the slideway, and the buffer block is located on a side of the stopping block adjacent to the inlet, the buffer block being configured to stop and buffer the embedding cassette; the pushing block is further enabled to drive the buffer block to move away from the slideway, so that the embedding cassette slides down to the stopping block;
wherein the slideway assembly comprises a blocking mechanism, the blocking mechanism comprises a first baffle and a second baffle, and the first baffle and the second baffle are respectively disposed on opposite sides of the slideway;
wherein the slideway further comprises the outlet corresponding to the material-carrying rail; the blocking mechanism further comprises the third baffle communicatively connected with the pushing block, the third baffle is movably disposed at the outlet, and the third baffle is configured to regulate a sliding direction of the embedding cassette according to a moving direction of the embedding cassette.
